(19) United States
(12) Patent Application Publication
(10) Pub. No.: US 2018/0155544 A1
(43) Pub. Date: Jun. 7, 2018

(54) Resin Compositions and Articles Manufactured Using the Same

(71) Applicant: Lotte Advanced Materials Co., Ltd., Yeosu-si (KR)

(72) Inventor: Jowon Lee, Uiwang-si (KR)

(21) Appl. No.: 15/819,403

(22) Filed: Nov. 21, 2017

(30) Foreign Application Priority Data
Dec. 5, 2016 (KR) 10-2016-0164424

(51) Int. Cl. C08L 69/00

(52) U.S. Cl. CPC C08L 69/00; C08L 2205/03; C08L 2201/08; C08L 2201/02

(57) ABSTRACT

A resin composition includes (A) a polycarbonate resin; (B) a branched polyorganosiloxane; (C) a borate-based inorganic compound; (D) a phosphorus-based flame retardant; and (E) talc. An article can be manufactured using the same.

### CROSS-REFERENCE TO RELATED APPLICATION

This application claims priority to and the benefit of Korean Patent Application No. 10-2016-0164424 filed in the Korean Intellectual Property Office on Dec. 5, 2016, the entire disclosure of which is incorporated herein by reference.

### FIELD

Resin compositions and articles manufactured using the same are disclosed.

### BACKGROUND

A plastic material used for a transportation interior material requires high flame retardant performance for safety of passengers against a fire during operation. Currently, although flame retardant performance requirements of the plastic material may differ for different countries, fire safety requirements commonly require low exothermicity, low smoke, low flame propagation velocity, and/or nontoxic smoke.

Requirements for resins used as a transportation interior material can simultaneously include various mechanical characteristics, flame retardancy, and low smoke characteristics. Examples of resins typically used for transportation interior materials include polyimide, polyaramid, and the like. There can be various problems associated with polycarbonate resins that prevent the use thereof as an interior material for transportation applications.

For example, a flame retardant can be added to a polycarbonate resin to improve flame retardancy. Excessively large amounts of the flame retardant, however, may be required to impart a necessary level of flame retardancy to the polycarbonate resin. This can deteriorate impact characteristics and decrease shear viscosity, preventing the use of the polycarbonate resin as a transportation material.

In addition, a flame retardant polycarbonate (PC) resin or a flame retardant polycarbonate/acrylonitrile-butadiene-styrene (PC/ABS) resin prepared by adding a phosphorous-based, a metal salt-based, or metal hydrate, and the like as a flame retardant may not pass the current European railroad fire safety standard EN45545-2.

U.S. Pat. No. 8,691,902 relates to a resin composition including a polycarbonate resin, an inorganic reinforcing material, polytetrafluoroethylene (PTFE), and an anti-drip agent and satisfies U.S. flame retardancy standards NFP 92-505 and NFX 10-702 but does not reach a maximum exothermic reference according to a maximum average rate of heat emission (MARHE) by a cone calorimeter according to EN45545-2. The low smoke characteristics of the resin may be improved by adding aluminum trioxide, magnesium dioxide, boehmite, and the like. Excessively large amounts thereof, however, may be required to achieve high flame retardancy and flame propagation velocity, which can deteriorate elasticity and thus limits its application.

### SUMMARY

An embodiment provides a resin composition that can have flame retardant, low-smoke, and/or low exothermic characteristics and also excellent mechanical properties.

Another embodiment provides an article including the thermoplastic resin composition.

In exemplary embodiments, a resin composition includes (A) a polycarbonate resin; (B) a branched polyorganosiloxane; (C) a borate-based inorganic compound; (D) a phosphorus-based flame retardant; and (E) talc.

The branched polyorganosiloxane may be represented by Chemical Formula 1:

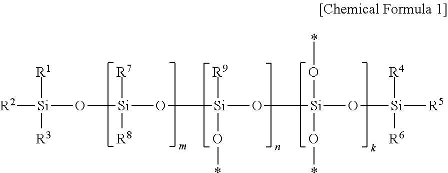

wherein, in Chemical Formula 1,

R¹ to R⁹ are the same or different and are each independently hydrogen, a hydroxy group, a halogen, a substituted or unsubstituted C1 to C30 alkyl group, a substituted or unsubstituted C2 to C30 alkenyl group, a substituted or unsubstituted C2 to C30 alkynyl group, a substituted or unsubstituted C3 to C30 cycloalkyl group, a substituted or unsubstituted C6 to C30 aryl group, a substituted or unsubstituted C1 to C30 heteroaryl group, —OR, —(C═O)R (wherein,

R is a hydroxy group, a substituted or unsubstituted C1 to C30 alkyl group, a substituted or unsubstituted C3 to C30 cycloalkyl group, a substituted or unsubstituted C6 to C30 aryl group, or a substituted or unsubstituted C7 to C30 arylalkyl group), and/or a combination thereof,

provided that at least one of R¹ to R⁶ is a C1 to C6 alkoxy group, a hydroxy group, a halogen, and/or a carboxyl group,

m, n, and k are the same or different and are each independently an integer ranging from 0 to 1,000, and

m+n+k>0.

The branched polyorganosiloxane may be an ultra-high molecular weight (UHMW) siloxane resin having a weight average molecular weight of greater than or equal to about 500,000 g/mol.

The branched polyorganosiloxane may be included in an amount of about 5 to about 15 parts by weight based on about 100 parts by weight of the polycarbonate resin.

The borate-based inorganic compound may be a zinc borate compound.

The borate-based inorganic compound may include one or more compounds selected from 2ZnO.3B₂O₃, ZnB₂O₄.2H₂O, Zn₂B₄O₈.3H₂O, Zn₂B₆O₁₁.7H₂O, Zn₂B₆O₁₁.9H₂O, Zn₃B₄O₉.5H₂O, Zn[B₃O₃(OH)₅]. H₂O, Zn₃(BO₃)₂, Zn₂B₆O₁₁, Zn₄B₂O₇.H₂O, Zn₂B₆O₁₁.3.5H₂O, and/or ZnB₄O₇.4H₂O.

The borate-based inorganic compound may be included in an amount of about 5 to about 15 parts by weight based on about 100 parts by weight of the polycarbonate resin.

The polycarbonate resin may include about 10 to about 90 wt % of a linear polycarbonate resin and about 90 to about 10 wt % of a branched polycarbonate resin, each based on the total weight (100 wt %) of the polycarbonate resin.

The phosphorus-based flame retardant may be included in an amount of about 1 to about 40 parts by weight and the talc retardant may be included in an amount of about 5 to about 50 parts by weight, each based on about 100 parts by weight of the polycarbonate resin.

In another embodiment, an article manufactured from the resin composition is provided.

The resin composition according to an embodiment can have improved flame retardant, low-smoke, and/or low exothermic characteristics and also can have improved mechanical properties.

### DETAILED DESCRIPTION

The present invention will be described more fully hereinafter, in which exemplary embodiments of the present invention are shown. This invention may, however, be embodied in many different forms and should not be construed as limited to the exemplary embodiments set forth herein. These exemplary embodiments disclosed in this specification are provided so that this disclosure will satisfy applicable legal requirements.

As used herein, when a specific definition is not otherwise provided, the term “alkyl group” refers to a C1 to C20 alkyl group, “alkenyl group” refers to a C2 to C20 alkenyl group, “cycloalkenyl group” refers to a C3 to C20 cycloalkenyl group, “heterocycloalkenyl group” refers to a C3 to C20 heterocycloalkenyl group, “aryl group” refers to a C6 to C20 aryl group, “arylalkyl group” refers to a C6 to C20 arylalkyl group, “alkylene group” refers to a C1 to C20 alkylene group, “arylene group” refers to a C6 to C20 arylene group, “alkylarylene group” refers to a C6 to C20 alkylarylene group, “heteroarylene group” refers to a C3 to C20 heteroarylene group, and “alkoxylene group” refers to a C1 to C20 alkoxylene group.

As used herein, when a specific definition is not otherwise provided, “substituted” refers to replacement of at least one hydrogen with one or more of a halogen atom (F, Cl, Br, or I), a hydroxy group, a C1 to C20 alkoxy group, a nitro group, a cyano group, an amine group, an imino group, an azido group, an amidino group, a hydrazino group, a hydrazono group, a carbonyl group, a carbamyl group, a thiol group, an ester group, an ether group, a carboxyl group or a salt thereof, a sulfonic acid group or a salt thereof, a phosphoric acid or a salt thereof, a C1 to C20 alkyl group, a C2 to C20 alkenyl group, a C2 to C20 alkynyl group, a C6 to C20 aryl group, a C3 to C20 cycloalkyl group, a C3 to C20 cycloalkenyl group, a C3 to C20 cycloalkynyl group, a C2 to C20 heterocycloalkyl group, a C2 to C20 heterocycloalkenyl group, a C2 to C20 heterocycloalkynyl group, a C3 to C20 heteroaryl group, and/or a combination thereof.

As used herein, when a specific definition is not otherwise provided, “hetero” refers to inclusion of at least one heteroatom of N, O, S and/or P in place of at least one carbon atom of a Chemical Formula.

As used herein, when a specific definition is not otherwise provided, “combination” refers to mixing and/or copolymerization.

As used herein, when a specific definition is not otherwise provided, “*” indicates a point where the same or different atom or chemical formula is linked.

Hereinafter, a resin composition according to an embodiment is described.

A resin composition according to an embodiment of the present invention includes (A) a polycarbonate resin, (B) a branched polyorganosiloxane, (C) a borate-based inorganic compound, (D) a phosphorus-based flame retardant, and (E) talc.

In general, a polycarbonate resin may be used for an impact resistance article, and a polycarbonate resin having high viscosity may be used for extrusion. However, polycarbonate resin typically may not be useful as a raw material for a transportation article (railroad cars, and the like) due to low flame retardancy as well as high maximum average rate of heat emission and high smoke density during the combustion. When a metal hydroxide-based flame retardant is added to the polycarbonate resin, the smoke density may be deteriorated, but the resin may be decomposed at a high temperature and thus not used for extrusion. In addition, a conventional polycarbonate resin can have a low critical flux at extinguishment (CFE) and thus can lack flame retardancy as a sheet.

However, the polycarbonate resin composition according to an embodiment includes branched polyorganosiloxane having an ultra-high molecular weight and thus can have excellent low exothermicity as well as reduced smoke amount and smoke density during combustion.

In addition, the resin composition according to an embodiment can exhibit flame retardancy synergic effect with the phosphorus-based flame retardant by including the borate-based inorganic compound, specifically a zinc borate compound.

Thereby, a resin composition having improved flame retardant, low-smoke, and/or low exothermic characteristics according to an embodiment may be provided and an article including the same can have a fast flame propagation velocity as well as excellent low exothermic heat, low smoke and/or flame retardant characteristics, and thus may be applicable to transportation article materials such as railroad cars sheet.

Hereinafter, each component of the resin composition is described in more detail.

(A) Polycarbonate Resin

A polycarbonate resin (A) according to exemplary embodiments may be a linear polycarbonate resin, a branched polycarbonate resin, or a mixture thereof. For example, the polycarbonate resin may include a linear polycarbonate resin and/or a branched polycarbonate resin.

The linear polycarbonate resin may include resin prepared from a phenolic compound, for example, a dihydric phenolic compound, and phosgene by a general preparation method in the presence of a molecular weight controlling agent and a catalyst. In addition, the linear polycarbonate resin may include resin prepared by ester exchange reaction of a phenolic compound, for example, a dihydric phenolic compound with a carbonate precursor, for example, diphenyl carbonate.

The branched polycarbonate resin may be prepared by reacting a multi-functional aromatic compound such as trimellitic anhydride and/or trimellitic acid with a dihydric phenolic compound and a carbonate precursor, but is not limited thereto.

The dihydric phenolic compound may include a bisphenol-based compound represented by Chemical Formula 2:

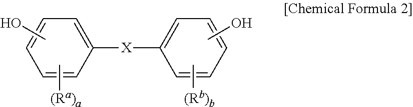

wherein, in Chemical Formula 2,

X is selected from a single bond, a substituted or unsubstituted C1 to C5 alkylene, a substituted or unsubstituted C1 to C5 alkylidene, a substituted or unsubstituted C3 to C6 cycloalkylene, a substituted or unsubstituted C5 to C6 cycloalkylidene, —CO, S, and SO2,

R^{a} and R^{b} are the same or different and are each independently a substituted or unsubstituted C1 to C30 alkyl group or a substituted or unsubstituted C6 to C30 aryl group, and

a and b are the same or different and are each independently 0 to 4.

The polycarbonate resin may have a weight average molecular weight (Mw) of about 10,000 to about 200,000 g/mol, for example, about 15,000 to about 80,000 g/mol.

A polycarbonate resin according to exemplary embodiments may include about 10 wt % to about 90 wt % of a linear polycarbonate resin and about 90 wt % to about 10 wt % of a branched polycarbonate resin, for example, about 20 wt % to about 80 wt % of the linear polycarbonate resin and about 80 wt % to about 20 wt % of the branched polycarbonate resin, and as another example, about 30 wt % to about 70 wt % of the linear polycarbonate resin and about 70 wt % to about 30 wt % of the branched polycarbonate resin, each based on the total weight (100 wt %) of the polycarbonate resin.

In some embodiments, the polycarbonate resin may include the linear polycarbonate resin in an amount of about 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, or 90 wt %. Further, according to some embodiments, the amount of the linear polycarbonate resin may be in a range from about any of the foregoing amounts to about any other of the foregoing amounts.

In some embodiments, the polycarbonate resin may include the branched polycarbonate resin in an amount of about 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, or 90 wt %. Further, according to some embodiments, the amount of the branched polycarbonate resin may be in a range from about any of the foregoing amounts to about any other of the foregoing amounts.

(B) Branched Polyorganosiloxane

The resin composition according to exemplary embodiments includes a branched polyorganosiloxane (B) in order to improve flame retardant, low-smoke, and/or low exothermic characteristics.

In the resin composition, the branched polyorganosiloxane is dispersed in the polycarbonate resin and can be transferred to a surface during combustion to form a barrier at the surface by a chemical reaction to prevent heat and oxygen and thereby to provide flame retardancy. In addition, the branched polyorganosiloxane can exhibit excellent low smoke characteristics compared with a linear siloxane resin. Thus, when a linear siloxane resin is used, melt strength may be deteriorated and a hard char may not formed during combustion, which can deteriorate/decrease flame retardancy.

The branched polyorganosiloxane may be represented by Chemical Formula 1:

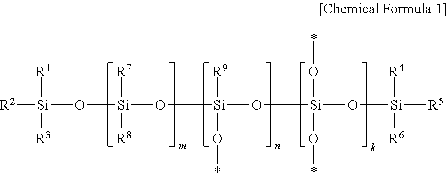

wherein, in Chemical Formula 1,

R¹ to R⁹ are the same or different and are each independently hydrogen, a hydroxy group, a halogen, a substituted or unsubstituted C1 to C30 alkyl group, a substituted or unsubstituted C2 to C30 alkenyl group, a substituted or unsubstituted C2 to C30 alkynyl group, a substituted or unsubstituted C3 to C30 cycloalkyl group, a substituted or unsubstituted C6 to C30 aryl group, a substituted or unsubstituted C1 to C30 heteroaryl group, —OR, —(C═O)R (wherein, R is a hydroxy group, a substituted or unsubstituted C1 to C30 alkyl group, a substituted or unsubstituted C3 to C30 cycloalkyl group, a substituted or unsubstituted C6 to C30 aryl group, or a substituted or unsubstituted C7 to C30 arylalkyl group), and/or a combination thereof,

with the proviso that at least one of R¹ to R⁶ is a C1 to C6 alkoxy group, a hydroxy group, a halogen, and/or a carboxyl group,

m, n, and k are the same or different and are each independently an integer ranging from 0 to 1,000, and

m+n+k>0.

For example, R⁷ to R⁹ of Chemical Formula 1 may independently be hydrogen and/or a substituted or unsubstituted C1 to C30 alkyl group.

For example, R⁷ to R⁹ of Chemical Formula 1 may independently be a C1 to C10 alkyl group, for example, a C1 to C10 alkyl group, and as another example, a C1 to C4 alkyl group.

For example, all R⁷ and R⁸ of Chemical Formula 1 may be a methyl group.

For example, a siloxane resin in a form of a powder can be added to the resin composition and thereby addition properties to the resin composition and internal polydispersity may be improved compared with a silicone rubber resin and/or a silicone gum.

In addition, the branched polyorganosiloxane is an ultra-high molecular weight (UHMW) siloxane resin and may have a weight average molecular weight of greater than or equal to about 500,000 g/mol, for example, greater than or equal to about 700,000 g/mol.

The resin composition may include the branched polyorganosiloxane in an amount of about 5 to about 15 parts by weight, for example about 5 to about 13 parts by weight, and as another example, about 5 to about 10 parts by weight, based on about 100 parts by weight of the polycarbonate resin. In some embodiments, the resin composition may include the branched polyorganosiloxane in an amount of about 5, 6, 7, 8, 9, 10, 11, 12, 13, 14, or 15 parts by weight. Further, according to some embodiments, the amount of the branched polyorganosiloxane may be in a range from about any of the foregoing amounts to about any other of the foregoing amounts.

When the amount of the branched polyorganosiloxane is less than about 5 parts by weight, low smoke characteristics may be deteriorated. When the amount of the branched polyorganosiloxane is greater than about 15 parts by weight, a melt index can become too high and thus flame retardancy of the resin composition may be deteriorated.

(C) Borate-based Inorganic Compound

The resin composition according to exemplary embodiments includes a borate-based inorganic compound (C). The borate-based inorganic compound may be thermally decomposed during combustion and swelled by H₂O to exist in a form of a molten product having a flame retardancy effect and can increase flame retardancy of the resin composition by being used with the phosphorus-based flame retardant.

The borate-based inorganic compound may be a borate-based compound including zinc, for example, one or more compounds selected from 2ZnO.3B₂O₃, ZnB₂O₄.2H₂O, Zn₂B₄O₈.3H₂O, Zn₂B₆O₁₁.7H₂O, Zn₂B₆O₁₁.9H₂O, Zn₃B₄O₉.5H₂O, Zn[B₃O₃(OH)₅].H₂O, Zn₃(BO₃)₂, Zn₂B₆O₁₁, Zn₄B₂O₇.H₂O, Zn₂B₆O₁₁.3.5H₂O, ZnB₄O₇.4H₂O, and the like. The borate-based inorganic compound, such as the borate-based compounds including zinc, may be used alone or in a mixture of two or more.

The resin composition may include the borate-based inorganic compound in an amount of about 5 to about 15 parts by weight, for example about 5 to about 13 parts by weight, and as another example about 5 to about 10 parts by weight, based on about 100 parts by weight of the polycarbonate resin. In some embodiments, the resin composition may include the borate-based inorganic compound in an amount of about 5, 6, 7, 8, 9, 10, 11, 12, 13, 14, or 15 parts by weight. Further, according to some embodiments, the amount of the borate-based inorganic compound may be in a range from about any of the foregoing amounts to about any other of the foregoing amounts.

Including the borate-based inorganic compound in an amount within the above ranges may improve impact strength of the resin composition.

(D) Phosphorus-based Flame Retardant

The resin composition according to exemplary embodiments includes a phosphorus-based flame retardant (D). The phosphorus-based flame retardant may be a phosphorus-based flame retardant generally used in a flame retardant resin composition. Examples of the phosphorus-based flame retardant may include without limitation phosphate compounds, phosphonate compounds, phosphinate compounds, phosphine oxide compounds, phosphazene compounds, metal salts thereof, and the like. The phosphorus-based flame retardant may be used alone or in a mixture of two or more.

For example, the phosphorus-based flame retardant may be a phosphoric acid ester compound represented by Chemical Formula 3 and/or a mixture thereof, but is not limited thereto:

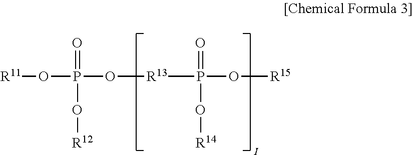

wherein, in Chemical Formula 3, R¹¹, R¹², R¹⁴, and R¹⁵ are the same or different and are each independently hydrogen, a substituted or unsubstituted C6 to C20 aryl group, a substituted or unsubstituted C7 to C30 arylalkyl group, and/or a combination thereof,

R¹³ is a substituted or unsubstituted C6 to C20 arylene group or a substituted or unsubstituted C7 to C30 arylalkyl group, and

I is an integer ranging from 0 to 4.

For example, the phosphoric acid ester compound represented by Chemical Formula 3 may be, when n is 0, diarylphosphate such as diphenylphosphate, triphenylphosphate, tricresyl phosphate, trixylenylphosphate, tri(2,6-dimethylphenyl)phosphate, tri(2,4,6-trimethylphenyl)phosphate, tri(2,4-ditertiarybutylphenyl)phosphate, tri(2,6-dimethylphenyl)phosphate, and the like, and when n is 1, bisphenol-A bis(diphenylphosphate), resorcinol bis(diphenylphosphate), resorcinol bis[bis (2,6-dimethylphenyl)phosphate], resorcinol bis[bis(2,4-ditertiarybutylphenyl)phosphate], hydroquinone bis[bis(2,6-dimethylphenyl)phosphate], hydroquinone bis[bis(2,4-ditertiarybutylphenyl)phosphate], but is not limited thereto. In addition, the phosphoric acid ester-based compound may be used alone or in a mixture of two or more.

The resin composition may include the phosphorus-based flame retardant in an amount of about 1 to about 40 parts by weight, for example about 1 to about 35 parts by weight, as another example about 3 to about 30 parts by weight, as another example about 5 to about 25 parts by weight, and as another example about 5 to 20 parts by weight, based on about 100 parts by weight of the polycarbonate resin. In some embodiments, the resin composition may include the phosphorus-based flame retardant in an amount of about 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, or 40 parts by weight. Further, according to some embodiments, the amount of the phosphorus-based flame retardant may be in a range from about any of the foregoing amounts to about any other of the foregoing amounts.

Including the phosphorus-based flame retardant in an amount within the above ranges may improve flame retardancy with minimal or no deterioration of other properties of the resin composition.

(E) Talc

The resin composition according to exemplary embodiments includes talc (E). The resin composition may exhibit improved heat resistance and/or flame retardancy with minimal or no deterioration of properties such as impact strength by including talc.

The talc may be a conventional, generally-used talc having a particle shape such as a sheet shape, a needle shape, and the like, and mixtures thereof.

The resin composition may include the talc in an amount of about 5 to about 50 parts by weight, for example about 10 to about 50 parts by weight, as another example about 10 to about 45 parts by weight, as another example about 10 to about 40 parts by weight, as another example about 10 to 35 parts by weight, and as another example about 15 to about 30 parts by weight, based on about 100 parts by weight of the polycarbonate resin. In some embodiments, the resin composition may include the talc in an amount of about 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, or 50 parts by weight. Further, according to some embodiments, the amount of the talc may be in a range from about any of the foregoing amounts to about any other of the foregoing amounts.

When the amount of the talc is less than about 5 parts by weight based on about 100 parts by weight of the polycarbonate resin, flame retardancy may be deteriorated. When the amount of the talc is greater than about 50 parts by weight, impact resistance may be deteriorated.

The resin composition according to the present invention may further include one or more other additives such as but not limited to an antioxidant, an ultraviolet (UV) stabilizer, a fluorescent whitening agent, a release agent, a nucleating agent, a lubricant, an antistatic agent, a stabilizer, an auxiliary flame retardant, a reinforcing material, a colorant such as a pigment and/or dye, and the like, and mixtures thereof, in accordance with the function of each, in addition to the constituting components. The other optional additive(s) may be included, for example, in an amount of about 0.1 to about 10 parts by weight based on about 100 parts by weight of the polycarbonate, although not limited thereto.

The resin composition may be prepared in a form of pellets by mixing the constituting components and optionally one or more other additives simultaneously and then melt extruding the same in an extruder. The prepared pellets may be manufactured into various articles through various molding methods as known in the art, such as but not limited to injection molding, extrusion molding, vacuum molding, casting molding, and the like.

An article according to exemplary embodiments includes the resin composition.

The article can have improved flame propagation velocity, low exothermic and/or low smoke characteristics while maintaining high intrinsic mechanical properties of the polycarbonate resin and may be particularly applied to a transportation raw material.

Hereinafter, the present disclosure is illustrated in more detail with reference to examples and comparative examples. These examples, however, are provided for the purpose of illustration only and are not in any sense to be interpreted as limiting the scope of the disclosure.

### EXAMPLES

The components used in Example 1 and Comparative Examples 1 to 9 are as follows:

(A) Polycarbonate (PC) Resin:

(A-1) Bisphenol A polycarbonate: branched PC (Manufacturer: Sabic)

(A-2) Bisphenol A polycarbonate: linear PC (Manufacturer: Samsung SDI)

(B) branched polyorganosiloxane: SM9520G (Manufacturer: KCC)

(C) borate-based inorganic compound: Firebrake ZB (Manufacturer: Rio-tinto)

(D) phosphorus-based flame retardant: bisphenol A diphosphate (Manufacturer: Yoke)

(E) talc: Jetfine 3CA (Manufacturer: Imerys)

(F) PC/silicone (Si)-gum master batch: MB50-315 (Manufacturer: Dow-corning)

### Example 1 and Comparative Examples 1 to 9

The resin compositions according to Example 1 and Comparative Examples 1 to 9 are prepared using the component type and amount shown in Table 1 and are respectively put in a twin screw type extruder having L/D=44 and a diameter 45 mm and then, melt and extruded at 250° C. and a stirring speed of 200 rpm condition to manufacture pellets. The pellets are dried at 80° C. for greater than or equal to 5 hours and ejected through a screw type injector (150 ton single injector) at 240° C. to 280° C. to manufacture specimens.

TABLE 1

| | | Comp. | Comp. | Comp. | Comp. | Comp. | Comp. | Comp. | Comp. | Comp. |
|---|---|---|---|---|---|---|---|---|---|---|
| | Ex. 1 | Ex. 1 | Ex. 2 | Ex. 3 | Ex. 4 | Ex. 5 | Ex. 6 | Ex. 7 | Ex. 8 | Ex. 9 |
| A-1 (wt %) | 70 | 70 | 70 | 70 | 70 | 70 | 70 | 70 | 70 | 70 |
| A-2 (wt %) | 30 | 30 | 30 | 30 | 30 | 30 | 30 | 30 | 30 | 30 |
| B | 8 | — | — | — | — | — | — | — | — | 4 |
| (parts by | | | | | | | | | | |
| weight) | | | | | | | | | | |
| C | 8 | — | 2 | 4 | 8 | 8 | 8 | — | 8 | 8 |
| (parts by | | | | | | | | | | |
| weight) | | | | | | | | | | |
| D | 11 | — | 11 | 11 | 11 | — | 11 | 11 | 11 | 11 |
| (parts by | | | | | | | | | | |
| weight) | | | | | | | | | | |
| E | 23 | — | 23 | 23 | — | 23 | 23 | 23 | 23 | 23 |
| (parts by | | | | | | | | | | |
| weight) | | | | | | | | | | |
| F | — | — | 8 | 8 | 8 | 8 | — | 8 | 8 | — |
| (parts by | | | | | | | | | | |
| weight) | | | | | | | | | | |

(parts by weight: parts by weight based on 100 parts by weight of polycarbonate resins (A-1) and (A-2))

### Evaluation

The properties of the specimens of Example 1 and Comparative Examples 1 to 9 are evaluated using the following methods, and the results are shown in Table 2.

(1) IZOD Impact strength: measured by making a notch in a ⅛″-thick Izod specimen according to ASTM D256.

(2) Melt index: measured at 300° C. under a load of 1.2 kgf according to ASTM D1238.

(3) Vicat softening temperature (VST): measured under a load of 5 kgf according to ASTM D1525.

(4) Flame retardancy: measured by making each 1.5 mm and 0.8 mm-thick specimen according to a UL-94 VB flame retardancy reference.

(5) Maximum average rate of heat emission (MARHE): measured with a cone calorimeter (Fire Testing Technology (FTT) Ltd.) according to ISO 5660-1.

A maximum average rate of heat emission (MARHE) may be defined as a maximum value of an average rate of heat emission (ARHE) during combustion. Mathematically, the average rate of heat emission (ARHE) corresponds to an integral of a thermal emission speed curve.

(6) Ds(4): obtained by measuring an amount of smoke at any particular time, that is, four minutes according to ISO 5659-2.

Ds(4)=(V/A*L)log(100/T)

(V: a volume of a testing chamber, A: an exposed area of a specimen, L: a length of light beam, T: relative transmittance (%) of light at 4 minutes)

(7) VOF4: obtained by measuring density of smoke generated at initial 4 minutes according to ISO 5659-2.

VOF4=[(Ds(1)+Ds(2)+Ds(3)+Ds(4)/2]×1 min

(8) Critical flux at extinguishment (CFE): measured according to ISO 5658-2.

The critical flux at extinguishment indicates a heat flux at a point where a flame spreads farthest from a center of combusting specimens and stops spreading.

TABLE 2

| | | Comp. | Comp. | Comp. | Comp. | Comp. | Comp. | Comp. | Comp. | Comp. |
|---|---|---|---|---|---|---|---|---|---|---|
| | Ex. 1 | Ex. 1 | Ex. 2 | Ex. 3 | Ex. 4 | Ex. 5 | Ex. 6 | Ex. 7 | Ex. 8 | Ex. 9 |
| Impact strength | 11.1 | 90 | 51.2 | 32.2 | 27.1 | 52.1 | 2.1 | 20.1 | 9.1 | 8.2 |
| (kgf · cm/cm) | | | | | | | | | | |
| Melt index | 6.1 | 7 | 7.7 | 8.6 | 6.1 | 3.2 | 7.1 | 18.5 | 5.1 | 4.8 |
| (300° C./ | | | | | | | | | | |
| 1.2 kgf) | | | | | | | | | | |
| VST (° C.) | 104 | 145 | 106 | 105 | 106 | 142 | 105 | 106 | 105 | 106 |
| UL 94 1.5T | V-0 | V-2 | V-0 | V-0 | V-0 | V-1 | V-0 | V-1 | V-0 | V-0 |
| UL 94 0.8T | V-0 | V-2 | V-0 | V-0 | V-0 | V-1 | V-0 | V-1 | V-0 | V-0 |
| Maximum | 83.2 | 227.2 | 111.4 | 105.6 | 137.8 | 164.7 | 151.2 | 187.2 | 85.2 | 92.2 |
| average rate of | | | | | | | | | | |
| heat emission | | | | | | | | | | |
| (kW/m²) | | | | | | | | | | |
| Ds (4) | 167 | 721 | 110 | 98 | 398 | 429 | 378 | 381 | 190 | 212 |
| VOF4 | 470 | 925 | 201 | 187 | 680 | 704 | 714 | 689 | 530 | 580 |
| CFE (kW/m²) | 24.2 | 8.8 | 16.8 | 18.2 | 11.1 | 13.1 | 15.1 | 11.1 | 23.1 | 20.1 |

Referring to Table 2, the resin composition of Example 1 exhibits excellent flame retardancy, impact resistance, flexibility, heat resistance, balance among these properties, and the like. In addition, the resin composition of Example 1 exhibits excellent low exothermicity and low smoke characteristics. Specifically, the resin composition of Example 1 exhibits all appropriate maximum average rate of heat emission, Ds(4) and VOF4 about a smoke amount and smoke density during the fire, and critical flux at extinguishment (CFE) for Europe test reference, EN45545-2 regarding fire safety standards. For reference, “pass” may be obtained according to EN45545-2 as follows:

MARHE ≤90 kW/m², Ds(4)≤300, VOF4≤600, CFE≥20 kW/m²

In contrast, Comparative Examples 1, 6, and 7 including no branched polyorganosiloxane and/or borate-based inorganic compound unlike Example 1 exhibit inferior low exothermicity and low smoke characteristics, and in particular, Comparative Examples 1 and 7 additionally exhibit inferior flame retardancy. In addition, among Comparative Examples 2 to 5 and 7, one including a linear Si-gum master batch having a similar molecular weight to that of the branched polyorganosiloxane instead of the borate-based inorganic compound but out of the content range of the borate-based inorganic compound according to the present invention exhibit a high maximum average rate of heat emission and a low heat flux (CFE).

The resin composition of Comparative Example 8 satisfies the requirements of EN45545-2 but exhibits insufficient low exothermicity and low smoke characteristics as well as insufficient physical characteristics such as impact strength, flexibility, and the like compared with the resin composition of Example 1. This effect difference is obtained, because the resin composition of Example 1 according to the present invention includes a branched siloxane resin which can prevent cracks in a char formed during the combustion due to improved melt strength. Accordingly, the present invention can exhibit excellent flame retardancy and low smoke characteristics due to an intumescent effect.

Many modifications and other embodiments of the invention will come to mind to one skilled in the art to which this invention pertains having the benefit of the teachings presented in the foregoing description. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation, the scope of the invention being defined in the claims.

What is claimed is:

1. A resin composition, comprising:
(A) a polycarbonate resin;
(B) a branched polyorganosiloxane;
(C) a borate-based inorganic compound;
(D) a phosphorus-based flame retardant; and
(E) talc.

2. The resin composition of claim 1, wherein the branched polyorganosiloxane is represented by Chemical Formula 1: 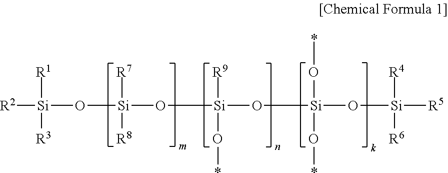
wherein, in Chemical Formula 1,
R¹ to R⁹ are the same or different and are each independently hydrogen, a hydroxy group, a halogen, a substituted or unsubstituted C1 to C30 alkyl group, a substituted or unsubstituted C2 to C30 alkenyl group, a substituted or unsubstituted C2 to C30 alkynyl group, a substituted or unsubstituted C3 to C30 cycloalkyl group, a substituted or unsubstituted C6 to C30 aryl group, a substituted or unsubstituted C1 to C30 heteroaryl group, —OR, —(C═O)R, wherein each R is independently a hydroxy group, a substituted or unsubstituted C1 to C30 alkyl group, a substituted or unsubstituted C3 to C30 cycloalkyl group, a substituted or unsubstituted C6 to C30 aryl group, and/or a substituted or unsubstituted C7 to C30 arylalkyl group, and/or a combination thereof,
provided that at least one of R¹ to R⁶ is a C1 to C6 alkoxy group, a hydroxy group, a halogen, and/or a carboxyl group,
m, n, and k are the same or different and are each independently an integer ranging from 0 to 1,000, and
m+n+k>0.

3. The resin composition of claim 1, wherein the branched polyorganosiloxane is an ultra-high molecular weight (UHMW) siloxane resin having a weight average molecular weight of greater than or equal to about 500,000 g/mol.

4. The resin composition of claim 1, comprising the branched polyorganosiloxane in an amount of about 5 to about 15 parts by weight based on about 100 parts by weight of the polycarbonate resin.

5. The resin composition of claim 1, wherein the borate-based inorganic compound is a zinc borate compound.

6. The resin composition of claim 5, wherein the borate-based inorganic compound comprises one or more compounds selected from 2ZnO.3B₂O₃, ZnB₂O₄.2H₂O, Zn₂B₄O₈.3H₂O, Zn₂B₆O₁₁.7H₂O, Zn₂B₆O₁₁.9H₂O, Zn₃B₄O₉.5H₂O, Zn[B₃O₃(OH)₅].H₂O, Zn₃(BO₃)₂, Zn₂B₆O₁₁, Zn₄B₂O₇.H₂O, Zn₂B₆O₁₁.3.5H₂O, and/or ZnB₄O₇.4H₂O.

7. The resin composition of claim 1, comprising the borate-based inorganic compound in an amount of about 5 to about 15 parts by weight based on about 100 parts by weight of the polycarbonate resin.

8. The resin composition of claim 1, wherein the polycarbonate resin includes about 10 to about 90 wt % of a linear polycarbonate resin and about 90 to about 10 wt % of a branched polycarbonate resin.

9. The resin composition of claim 1, comprising the phosphorus-based flame retardant in an amount of about 1 to about 40 parts by weight and the talc retardant in an amount of about 5 to about 50 parts by weight, each based on about 100 parts by weight of the polycarbonate resin.

10. An article manufactured from the resin composition of claim 1.
